(19) United States
(12) Patent Application Publication
(10) Pub. No.: US 2021/0375068 A1
(43) Pub. Date: Dec. 2, 2021

(54) COMPUTER READABLE RECORDING MEDIUM, PAYMENT SYSTEM, AND PAYMENT SERVER

(71) Applicant: TOYOTA JIDOSHA KABUSHIKI KAISHA, Toyota-shi (JP)

(72) Inventors: Tomokazu MAYA, Nagoya-shi (JP); Naoki YAMAMURO, Nagoya-shi (JP); Yuki NAKATANI, Tokyo (JP); Kosuke MIYAKE, Tokyo (JP); Soushi MIZUNO, Tokyo (JP); Yasushi FURUHATA, Kodaira-shi (JP); Masataka NARITA, Tokyo (JP); Yasuhiro TAKEHARA, Nagoya-shi (JP)

(73) Assignee: TOYOTA JIDOSHA KABUSHIKI KAISHA, Toyota-shi (JP)

(21) Appl. No.: 17/242,438

(22) Filed: Apr. 28, 2021

(30) Foreign Application Priority Data
May 28, 2020 (JP) 2020-093709

(51) Int. Cl. G07B 15/02; G06Q 20/10; G06Q 20/36

(52) U.S. Cl. CPC G07B 15/02; G06Q 20/363; G06Q 20/102

(57) ABSTRACT

Provided is a non-transitory computer-readable recording medium on which an executable program is recorded, the program causing a processor of a computer to execute outputting, to a display, information obtained by a comparison between a parking fee that increases in accordance with a lapse of a parking duration in a toll parking lot and a balance of a payment method.

The present application claims priority to and incorporates by reference the entire contents of Japanese Patent Application No. 2020-093709 filed in Japan on May 28, 2020.

### BACKGROUND

The present disclosure relates to a computer readable recording medium, a payment system, and a payment server.

JP 2004-69551 A discloses a device that causes a display unit of a mobile terminal to display an elapsed time and a parking fee in parking a vehicle in a toll parking lot. This technique enables a user to grasp a parking fee even at a place away from his/her vehicle.

### SUMMARY

It has been needed to improve the convenience of electronic money for use in payment of a parking fee.

There is a need for a computer readable recording medium, a payment system, and a payment server that improve the convenience of electronic money.

According to the present disclosure, there is provided a non-transitory computer-readable recording medium on which an executable program is recorded, the program causing a processor of a computer to execute outputting, to a display, information obtained by a comparison between a parking fee that increases in accordance with a lapse of a parking duration in a toll parking lot and a balance of a payment method.

### BRIEF DESCRIPTION OF THE DRAWINGS

FIG. 1 is a diagram that schematically illustrates a configuration of a wallet system including a payment server according to an embodiment;

FIG. 2 is a block diagram that illustrates the details of constituent elements in the wallet system including the payment server according to the embodiment;

FIG. 3 is a diagram that schematically illustrates a relationship between a wallet and a payment method, in the wallet system including the payment server according to the embodiment;

FIG. 4 is a diagram that illustrates an example in which an operation and display unit of a user terminal displays a list of payment methods, in the payment server according to the embodiment;

FIG. 5 is a diagram that illustrates an example in which the operation and display unit of the user terminal displays a warning display screen, in the payment server according to the embodiment;

FIG. 6 is a diagram that illustrates an example in which the operation and display unit of the user terminal displays a warning display screen, in the payment server according to the embodiment;

FIG. 7 is a diagram that illustrates an example in which the operation and display unit of the user terminal displays a warning display screen, in the payment server according to the embodiment; and

FIG. 8 is a diagram that illustrates an example in which the operation and display unit of the user terminal displays a warning display screen, in the payment server according to the embodiment.

### DETAILED DESCRIPTION

With reference to the drawings, a description will be given of a computer readable recording medium storing a payment program, a payment system, and a payment server according to an embodiment of the present disclosure. It should be noted that constituent elements to be described in the following embodiment include those replaceable by a person skilled in the art with ease or those substantially identical therewith.

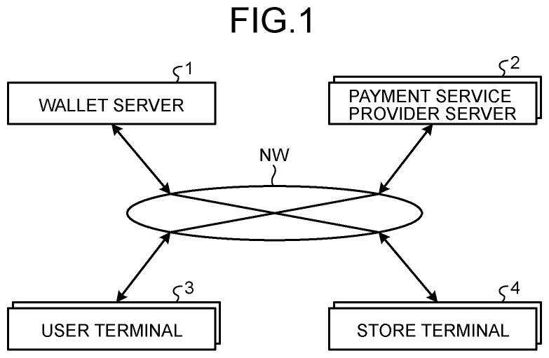

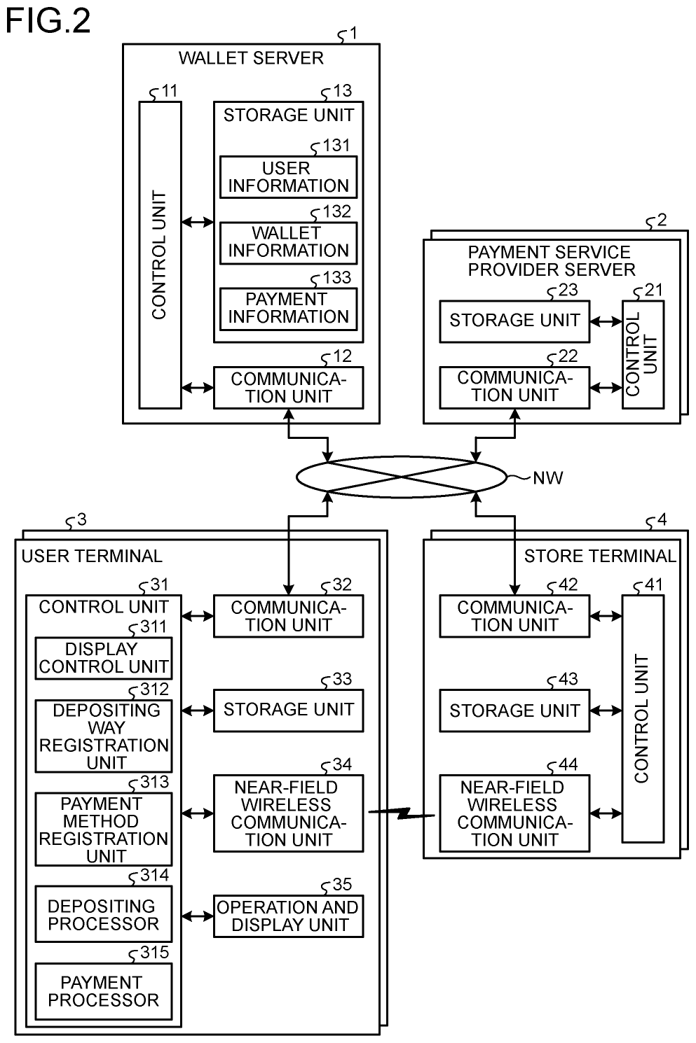

With reference to FIGS. 1 and 2, a description will be given of a configuration of a wallet system that executes the payment program according to the embodiment. As illustrated in FIG. 1, the wallet system includes a wallet server 1, a payment service provider server 2, a user terminal 3, and a store terminal 4.

The wallet server 1, the payment service provider server 2, the user terminal 3, and the store terminal 4 are configured to enable mutual communications via a network NW. The network NW is constituted of, for example, an Internet network, a mobile phone network, or the like.

The wallet server 1 is a server for comprehensively managing the wallet system in which a plurality of payment methods are registered, and an administrator of the wallet system manages the wallet server 1. However, the wallet server 1 may be a payment server in which one payment method is registered. As illustrated in FIG. 2, the wallet server 1 includes a control unit (a first processor) 11, a communication unit 12, and a storage unit 13.

Specifically, the control unit 11 includes a processor including a central processing unit (CPU), a digital signal processor (DSP), a field-programmable gate array (FPGA), and the like, and a memory (a main storage unit) including a random access memory (RAM), a read only memory (ROM), and the like.

The control unit 11 loads a program stored in the storage unit 13 onto a working region of the main storage unit, and executes the program to control each constituent element or the like. The control unit 11 thus enables a function according to a predetermined purpose.

The communication unit 12 includes, for example, a local area network (LAN) interface board, a wireless communication circuit for wireless communications, and the like. The communication unit 12 is connected to the network NW, such as the Internet, which is a public communication network. The communication unit 12 is connected to the network NW to communicate with the payment service provider server 2, the user terminal 3, and the store terminal 4.

The storage unit 13 includes a recording medium. Examples of the recording medium may include, but not limited to, an erasable programmable ROM (EPROM), a hard disk drive (HDD), and a removable medium. Examples of the removable medium may include disc recording media such as a universal serial bus (USB) memory, a compact disc (CD), a digital versatile disc (DVD), and a Blu-ray (registered trademark) disc (BD). The storage unit 13 is capable of storing an operating system (OS), various programs, various tables, various databases, and the like. The storage unit 13 according to the present embodiment stores user information 131, wallet information 132, and payment information 133 for each user of the wallet system.

The user information 131 is information on a user who uses the wallet system. Examples of the user information 131 on a user who has signed up for the wallet system may include, but not limited to, a user ID, a password, a user's name, contact information (e.g., an address, a phone number, an e-mail address, etc.) of the user, a record of a sign-up, information on a registered payment method, information on another payment method registered for depositing into a payment method, and a personal identification number in making payment. Among the various kinds of user information 131, the user ID and the password are used for authentication processing such as login to the wallet server 1.

The wallet information 132 is information on a wallet of the wallet system. The term “wallet” refers to an application for managing virtual deposit and withdrawal using various payment methods such as a credit card and electronic money. Examples of the wallet information 132 may include, but not limited to, a user ID, a payment method, the balance of electronic money, a record of electronic money deposited, and a record of electronic money used.

The payment information 133 is information on payment in the wallet system. Example of the payment information 133 may include, but not limited to, a user ID, a payment way used for payment (e.g., payment with electronic money (contactless payment), payment by scanning, payment with a code, etc.), and a record of payment.

The payment service provider server 2 is a server for managing an account and a credit card of a user. The payment service provider server 2 is installed in a financial institution (e.g., a bank, a credit association, a credit union, a worker's credit union, etc.) and a credit card company. The payment service provider server 2 includes a control unit 21, a communication unit 22, and a storage unit 23. The control unit 21, the communication unit 22, and the storage unit 23 are respectively similar to the control unit 11, the communication unit 12, and the storage unit 13 in a physical aspect.

The storage unit 23 stores account information and credit card information for each user of the wallet system. Examples of the account information may include, but not limited to, a user's name, an account number, an account balance, and a record of deposit and withdrawal. Examples of the credit card information may include, but not limited to, a user's name, a credit card number, an expiration date of a credit card, a total credit limit, and a record of a credit card used.

The user terminal 3 is a computer terminal which a user uses. Examples of the user terminal 3 of the user may include, but not limited to, a smartphone, a mobile phone, a tablet terminal, a wearable computer, a personal computer, and a car navigation system installed in a vehicle. The user terminal 3 may be any terminal as long as it is capable of exchanging information with the wallet server 1.

The user terminal 3 includes a control unit (a second processor) 31, a communication unit 32, a storage unit 33, a near-field wireless communication unit 34, and an operation and display unit (a display) 35. The control unit 31, the communication unit 32, and the storage unit 33 are respectively similar to the control unit 11, the communication unit 12, and the storage unit 13 in a physical aspect. The control unit 31 executes programs to function as a display control unit 311, a depositing way registration unit 312, a payment method registration unit 313, a depositing processor 314, and a payment processor 315.

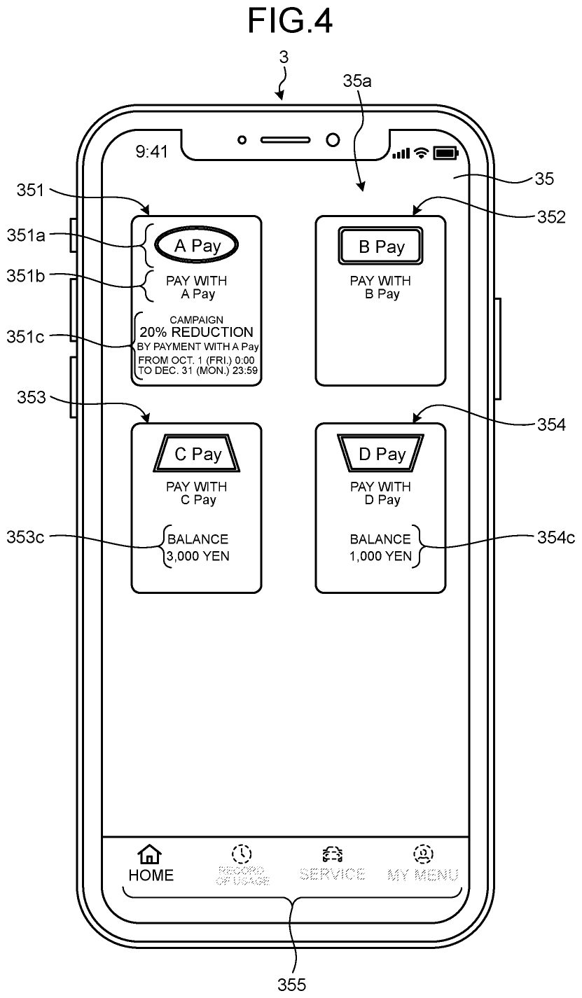

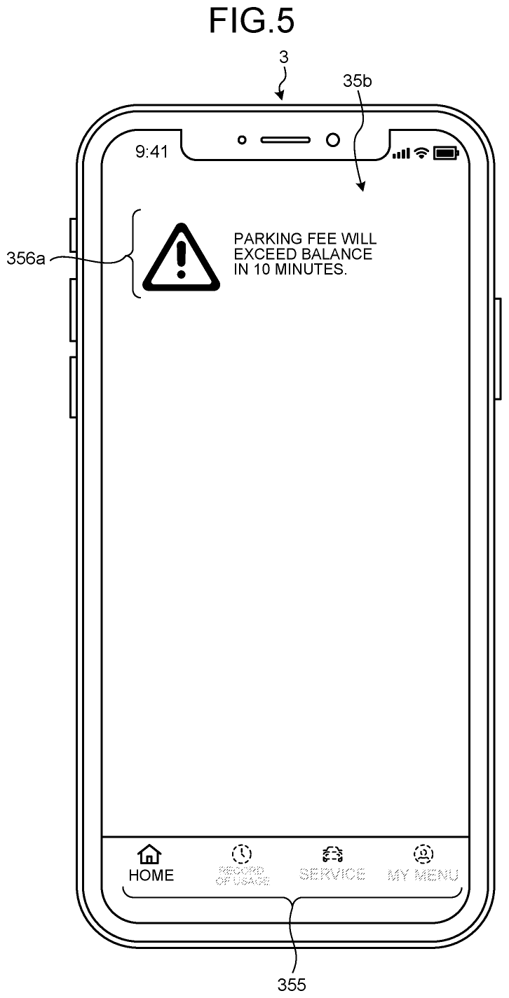

The display control unit 311 controls the details of display on the operation and display unit 35. The display control unit 311 causes the operation and display unit 35 to display a sign-up screen for a user to sign up for the wallet system, a login screen for logging in the wallet system, a deposit screen for depositing electronic money into a wallet, a payment method selection screen 35a (see FIG. 4) for payment, a warning display screen 35b (see FIGS. 5 to 8) for displaying a warning message, and the like, based on a user operation (e.g., a touch, a flick, etc.). In addition, the display control unit 311 causes a transition from one screen to another screen, based on a user operation.

The depositing way registration unit 312 registers a depositing way for depositing electronic money. Specifically, the depositing way registration unit 312 transmits, to the wallet server 1, a depositing way registration request for registering different payment methods (e.g., a bank account, a credit card, etc.) operated by a plurality of service providers, as a depositing way for depositing electronic money. When receiving the depositing way registration request from the depositing way registration unit 312, the control unit 11 of the wallet server 1 causes the storage unit 13 to store the payment methods contained in the depositing way registration request as user information 131, thereby registering the payment methods as depositing ways.

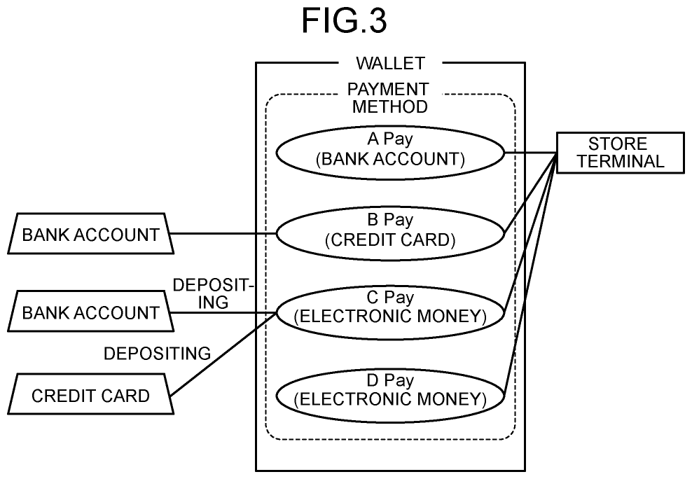

FIG. 3 is a diagram that schematically illustrates a relationship between a wallet and a payment method in the wallet system. The term “payment method” refers to a funding source for payment. A plurality of payment methods are registered in the wallet. Examples of the payment methods may include, but not limited to, “A Pay” corresponding to payment with a bank account, “B Pay” corresponding to payment with a credit card, “C Pay” corresponding to payment with electronic money, and “D Pay” corresponding to payment with electronic money. “A Pay” is a payment method of directly deducting a payment amount from a bank account. Credit cards (“B Pay”) are respectively associated with bank accounts. When each credit card is used, a payment amount is deducted from the corresponding bank account at a later date. Electronic money (“C Pay”) is associated with depositing ways, such as a bank account and a credit card, as ways to deposit electronic money. Electronic money may thus be deposited into the depositing ways. Electronic money (“D Pay”) is not necessarily associated with depositing ways, such as a bank account and a credit card, in a case of a prepaid system of depositing cash or the like in advance.

The user selects one of the payment methods to make payment between the user terminal 3 and the store terminal 4. Specifically, the user executes payment ways such as payment to be made in a contactless manner between the near-field wireless communication unit 34 of the user terminal 3 and a near-field wireless communication unit 44 of the store terminal 4 in such a manner that the user holds the user terminal 3 over the store terminal 4, payment to be made in such a manner that a barcode or a QR code (registered trademark) displayed on the store terminal 4 is read by a camera or the like of the user terminal 3, and payment to be made in such a manner that a barcode or a QR code (registered trademark) displayed on the user terminal 3 is read by a code reader or the like of the store terminal 4.

The payment method registration unit 313 registers the various payment methods. The payment method registration unit 313 transmits, to the wallet server 1, a payment method registration request for registering the payment methods. When receiving the payment method registration request from the payment method registration unit 313, the control unit 11 of the wallet server 1 causes the storage unit 13 to store the payment methods contained in the payment method registration request as user information 131, thereby registering the payment methods as payment methods.

The depositing processor 314 deposits electronic money into the wallet. Specifically, the depositing processor 314 transmits, to the wallet server 1, a depositing request for depositing electronic money, by the payment method registered as the depositing way. When receiving the depositing request from the depositing processor 314, the control unit 11 of the wallet server 1 increases the balance of electronic money in the wallet, based on deposit amount information contained in the depositing request. In other words, the control unit 11 updates wallet information 132 stored in the storage unit 13, in accordance with the increase in balance of electronic money in the wallet.

The payment processor 315 makes payment by the payment method which the user selects. Specifically, the payment processor 315 transmits a payment request to the store terminal 4 through the near-field wireless communication unit 34, as a payment way. The payment processor 315 may transmit the payment request to the store terminal 4 in such a manner that a barcode or a QR code (registered trademark) displayed on the store terminal 4 is read by the camera or the like of the user terminal 3, as the payment way. Alternatively, the payment processor 315 may transmit the payment request to the store terminal 4 in such a manner that a barcode or a QR code (registered trademark) displayed on the user terminal 3 is read by the code reader or the like of the store terminal 4, as the payment way. The payment request to be transmitted from the payment processor 315 to the store terminal 4 may contain information indicating a payment amount (hereinafter, referred to as “payment amount information”) or does not necessarily contain payment amount information.

In the payment with the bank account or the credit card, subsequently, the payment processor 315 transmits, to the wallet server 1, a payment request for making payment using one of the payment ways. When receiving the payment request from the payment processor 315, the control unit 11 of the wallet server 1 transmits, to the payment service provider server 2, payment amount information contained in the payment request.

In the case where the payment processor 315 makes the payment with the electronic money, a control unit 41 of the store terminal 4 transmits a payment request containing payment amount information to the wallet server 1 via the network NW. When receiving the payment request from the store terminal 4, the control unit 11 of the wallet server 1 decreases the balance of electronic money in the wallet, based on the payment amount information contained in the payment request. In other words, the control unit 11 updates the wallet information 132 and payment information 133 stored in the storage unit 13, in accordance with the decrease in balance of electronic money in the wallet.

The storage unit 33 stores data of various screens which the display control unit 311 causes the operation and display unit 35 to display. The storage unit 33 temporarily stores the user information 131, the wallet information 132, the payment information 133, and the like as required.

The near-field wireless communication unit 34 has communication functions aligned with the standards such as near field radio communication (NFC), Bluetooth (registered trademark) low energy (BLE), and infrared data association (IrDA). The user terminal 3 establishes near-field wireless communications with the store terminal 4 through the near-field wireless communication unit 34 in making payment with, for example, electronic money.

The operation and display unit 35 includes, for example, a touch panel display. The operation and display unit 35 has an input function of accepting an operation through a user's finger, a pen, or the like, and a display function of displaying various kinds of information, based on the control by the display control unit 311.

The store terminal 4 is installed in, for example, a store (a member store) in which the wallet system is available. However, the store terminal 4 may be a server that functions as a virtual store on the Internet (i.e., an “electronic commerce site”). The store terminal 4 includes a control unit 41, a communication unit 42, a storage unit 43, and a near-field wireless communication unit 44. The control unit 41, the communication unit 42, the storage unit 43, and the near-field wireless communication unit 44 are respectively similar to the control unit 11, the communication unit 12, the storage unit 13, and the near-field wireless communication unit 34 in a physical aspect.

With reference to FIGS. 4 to 8, next, a description will be given of display control which the display control unit 311 performs on the operation and display unit 35 in the wallet system including the wallet server 1 according to the present embodiment.

First, the user terminal 3 acquires information identifying a toll parking lot in which the user has parked his/her vehicle. Specifically, the user terminal 3, such as a smartphone, acquires the information identifying the toll parking lot in which the user has parked his/her vehicle, by contactless communications between the user terminal 3 and the store terminal 4 which is a terminal installed in the parking lot or in such a manner that a barcode or a QR code (registered trademark) displayed on the store terminal 4 is read by the camera or the like of the user terminal 3. Alternatively, the user terminal 3 may identify the toll parking lot in which the user has parked his/her vehicle, based on positional information of the user terminal 3 measured with a signal received from a global positioning system (GPS) satellite. Alternatively, the user terminal 3 may identify the toll parking lot in which the user has parked his/her vehicle, from a name, an address, and the like which the user inputs thereto. The wallet server 1 receives, from the user terminal 3, information on the toll parking lot in which the user has parked his/her vehicle, thereby identifying the toll parking lot in which the user has parked his/her vehicle.

Next, the wallet server 1 acquires an entering time of day at which the vehicle of the user entered the toll parking lot. Specifically, the wallet server 1 acquires, as the entering time of day, a time of day at which the wallet server 1 identified the toll parking lot in which the user has parked his/her vehicle. Alternatively, the wallet server 1 may acquire, as the entering time of day, a time of day at which the wallet server 1 determined, based on the positional information of the user terminal 3 measured with the signal received from the GPS satellite, that the positional information of the user terminal 3 coincides with the toll parking lot. Alternatively, the wallet server 1 may acquire, as the entering time of day, a time of day which the user input.

In addition, the wallet server 1 acquires a fee structure of the toll parking lot (a schedule of fees for the toll parking lot). Specifically, the wallet server 1 communicates with the store terminal 4 installed in the toll parking lot to acquire the fee structure of the toll parking lot. The fee structure of the toll parking lot is information on a parking fee per unit time, such as 1000 yen per hour. The parking fee varies depending on a time zone, day of the week, and the like in some cases. Alternatively, an upper limit value is set for the parking fee in some cases.

Thereafter, the user terminal 3 accepts a selected one of the payment methods to be used when the vehicle leaves the toll parking lot. FIG. 4 illustrates an exemplary payment method selection screen 35a which the display control unit 311 causes the operation and display unit 35 to display. FIG. 4 illustrates an exemplary payment method selection screen 35a in a case where “A Pay”, “B Pay”, “C Pay”, and “D Pay” are registered as the payment methods. Specifically, the payment method selection screen 35a includes payment icons 351 to 354 displayed in a list form, and a menu selection region 355.

Each of the payment icons 351 to 354 is a region where a payment method is displayed, and accepts a request for selecting the displayed payment method. The display control unit 311 displays, on the payment icon 351, a payment name 351a indicating a name of a payment method available in the user terminal 3, a payment phrase 351b explicitly indicating that payment is made by the payment method, and a payment information region 351c where additional information on the payment method is displayed.

Specifically, the payment icon 351 displays, as the payment name 351a, an emblem (e.g., a logo mark, an acceptance mark, etc.) including the name of “A Pay”. The payment icon 351 also displays, as the payment phrase 351b, characters “Pay with A Pay”. The payment icon 351 also displays, as the payment information region 351c, campaign information on service of “A Pay”. Each of the payment icons 352 to 354 displays the name of the corresponding payment method, an emblem indicating the corresponding payment method, a payment phrase, additional information, and the like. Each of the payment icons 352 to 354 is similar to the payment icon 351 in a functional aspect.

A payment information region 353c for “C Pay” corresponding to the payment with the electronic money displays the balance of electronic money, 3000 yen. A payment information region 354c for “D Pay” corresponding to the payment with the electronic money displays the balance of electronic money, 1000 yen.

As illustrated in FIG. 4, in a case where the user selects the payment icon 353 indicating “C Pay”, the balance of electronic money in “C Pay” is 3000 yen. At this time, the display control unit 311 causes the display to display information obtained by a comparison between the parking fee that increases in accordance with a lapse of the parking duration in the toll parking lot and the balance of the payment method, under the control by the wallet server 1. Specifically, the wallet server 1 calculates an available parking duration corresponding to a time during which the vehicle may be parked in the toll parking lot within a range of the balance, and the display control unit 311 causes the operation and display unit 35 to display the available parking duration thus calculated. For example, in a case where the fee structure of the toll parking lot indicates 1000 yen per hour, the wallet server 1 calculates that the available parking duration is three hours corresponding to a time during which the vehicle may be parked in the toll parking lot within the range of the balance of 3000 yen. The display control unit 311 causes the operation and display unit 35 to display a message that the available parking duration is three hours.

When a time up to the end of available parking duration falls below a predetermined time, the wallet server 1 may display the warning message on the display. In the wallet server 1, specifically, when the parking duration since the vehicle entered the toll parking lot exceeds two hours and 50 minutes, and the time up to the end of available parking duration of three hours falls below a predetermined time of 10 minutes, the display control unit 311 causes the operation and display unit 35 to display the warning message. FIG. 5 illustrates an exemplary warning display screen 35b which the display control unit 311 causes the operation and display unit 35 to display. FIG. 5 illustrates an exemplary warning message “Parking fee will exceed balance in 10 minutes.” displayed in a warning display region 356a. As a result, the user may recognize until when the parking fee can be paid with the balance in “C Pay”. This configuration thus enables improvement in convenience of electronic money.

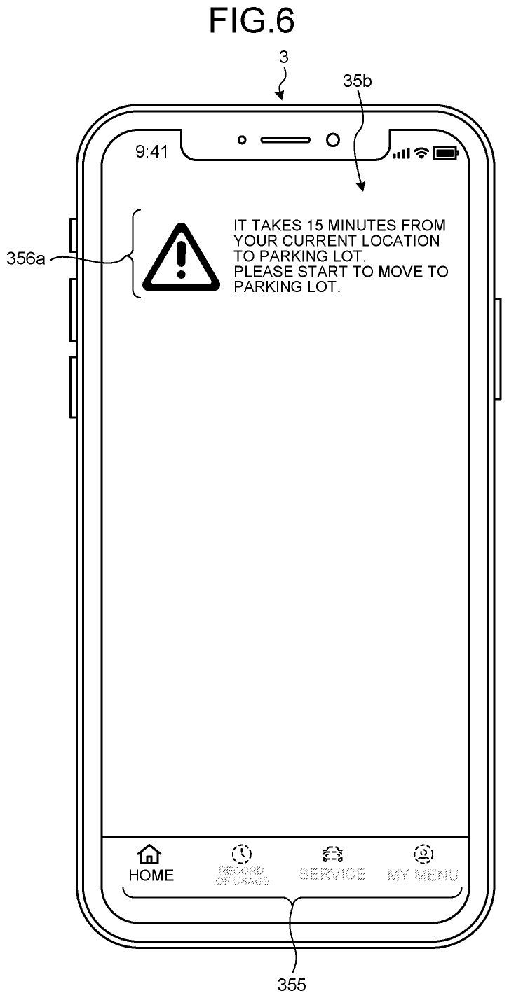

In addition, the wallet server 1 calculates a moving duration for the user to move from the current location to the toll parking lot. When the time up to the end of available parking duration falls below a sum of the moving duration and a predetermined time, the wallet server 1 may display a warning message on the display. Specifically, the wallet server 1 acquires the current location, based on the positional information of the user terminal 3 measured with the signal received from the GPS satellite, and calculates the moving duration for the user to move from the current location to the position of the toll parking lot acquired in advance. For example, it is assumed that the moving duration is 15 minutes. In the wallet server 1, when the parking duration since the vehicle entered the toll parking lot exceeds two hours and 35 minutes, and the time up to the end of available parking duration of three hours falls below 25 minutes which is the sum of the moving duration of 15 minutes and the predetermined time of 10 minutes, the display control unit 311 causes the operation and display unit 35 to display the warning message. FIG. 6 illustrates an exemplary warning display screen 35b which the display control unit 311 causes the operation and display unit 35 to display. FIG. 6 illustrates an exemplary warning message “It takes 15 minutes from your current location to parking lot. Please start to move to parking lot.” displayed in the warning display region 356a. As a result, the user may recognize that the time after which the parking fee cannot be paid with the balance in “C Pay” is approaching, in consideration of the moving duration from the current location to the toll parking lot. This configuration thus enables improvement in convenience of electronic money. In this case, the wallet server 1 may display a moving route from the current location to the toll parking lot on the display subsequent to the screen illustrated in FIG. 6. As a result, the user may grasp the moving route from the current location to the toll parking lot. This configuration further enables improvement in convenience of electronic money.

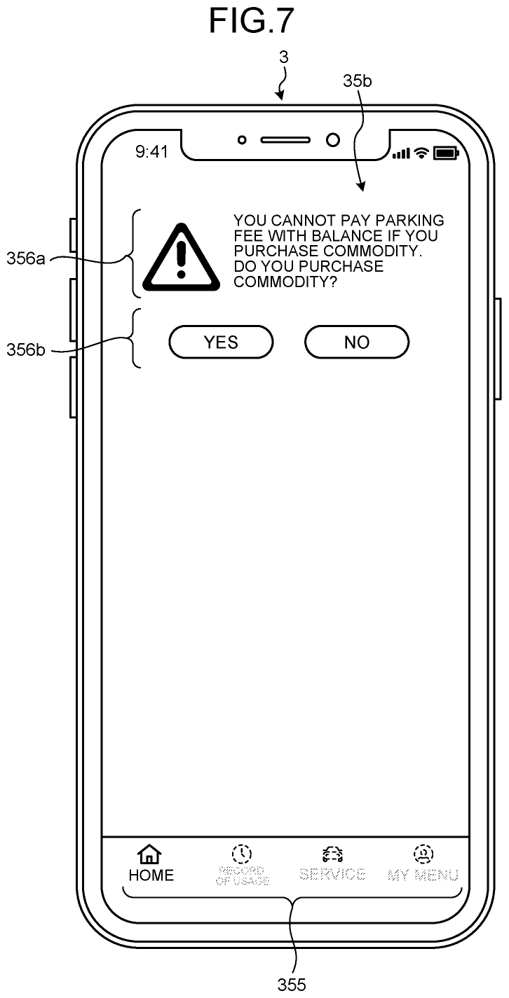

In addition, the wallet server 1 accepts a payment request for a predetermined payment amount, and determines whether a sum of the payment amount and the parking fee exceeds the balance. When the wallet server 1 determines that the sum exceeds the balance, then the wallet server 1 may display a warning message on the display. Specifically, when the wallet server 1 accepts a payment request for the user to purchase a commodity of which the payment amount is 1000 yen, through communications between the user terminal 3 and a store terminal different from the store terminal 4, then the wallet server 1 calculates a sum of the payment amount of 1000 yen and the parking fee at this point in time, and determines whether the sum exceeds the balance of 3000 yen. In the wallet server 1, for example, when the parking fee at this point in time is 2500 yen, and the sum exceeds the balance, the display control unit 311 causes the operation and display unit 35 to display the warning message. FIG. 7 illustrates an exemplary warning display screen 35b which the display control unit 311 causes the operation and display unit 35 to display. FIG. 7 illustrates an exemplary warning message “You cannot pay parking fee with balance if you purchase commodity. Do you purchase commodity?” displayed in the warning display region 356a. FIG. 7 also illustrates exemplary buttons “Yes” and “No” for accepting a choice as to whether to purchase a commodity, the buttons being displayed in a selection region 356b. As a result, the user may recognize that he/she cannot pay the parking fee with the balance if he/she purchases a commodity, and may also easily decide whether to purchase the commodity. This configuration thus enables improvement in convenience of electronic money.

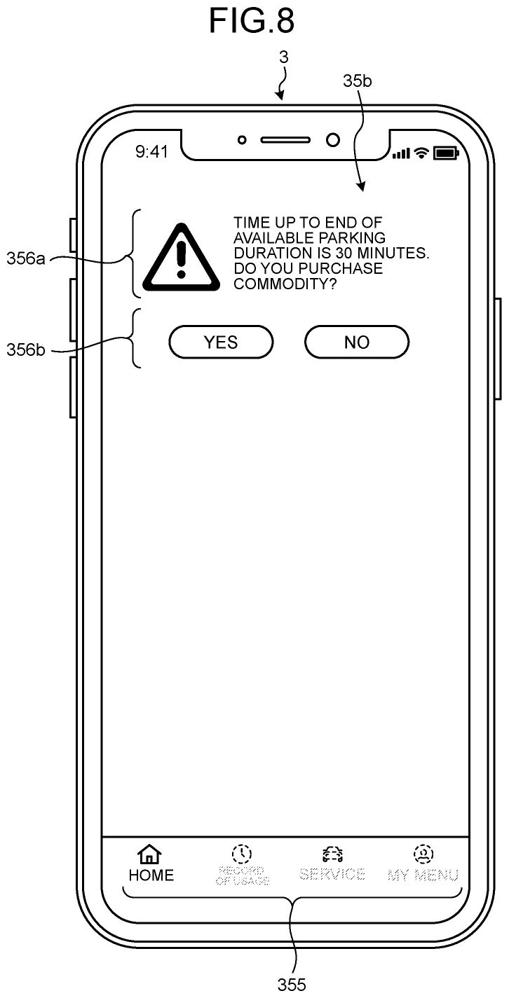

In the wallet server 1, when the parking fee at the time when the wallet server 1 accepted the payment request is 1500 yen, and the sum does not exceed the balance, the display control unit 311 may cause the operation and display unit 35 to display a warning message. The wallet server 1 calculates that the remaining available parking duration is 30 minutes corresponding to a time during which the vehicle may be parked in the toll parking lot within the range of the balance of 500 yen obtained by subtracting 2500 yen as the sum of the payment amount of 1000 yen and the parking fee of 1500 yen from the balance of 3000 yen. FIG. 8 illustrates an exemplary warning display screen 35b which the display control unit 311 causes the operation and display unit 35 to display. FIG. 8 illustrates an exemplary warning message “Time up to end of available parking duration is 30 minutes. Do you purchase commodity?” displayed in the warning display region 356a. FIG. 8 also illustrates exemplary buttons “Yes” and “No” for accepting a choice as to whether to purchase a commodity, the buttons being displayed in the selection region 356b. As a result, the user may recognize the remaining available parking duration in the case where he/she purchases a commodity, and may also easily decide whether to purchase the commodity. This configuration thus enables improvement in convenience of electronic money.

As described above, the payment program, payment system, and payment server according to the embodiment are capable of improving convenience of electronic money to be used for payment of a parking fee. It should be noted that even a payment server in which one kind of electronic money is available may cause a display to display information obtained by a comparison between a parking fee and the balance of electronic money. This configuration thus enables improvement in convenience of electronic money.

The present disclosure enables improvement in convenience of electronic money.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A non-transitory computer-readable recording medium on which an executable program is recorded, the program causing a processor of a computer to execute
outputting, to a display, information obtained by a comparison between a parking fee that increases in accordance with a lapse of a parking duration in a toll parking lot and a balance of a payment method.

2. The non-transitory computer-readable recording medium according to claim 1, wherein the program causes the processor to execute acquiring an entering time of day at which a vehicle enters the toll parking lot.

3. The non-transitory computer-readable recording medium according to claim 1, wherein the program causes the processor to execute acquiring a fee structure of the toll parking lot.

4. The non-transitory computer-readable recording medium according to claim 1, wherein the program causes the processor to:
execute calculating an available parking duration corresponding to a time during which a vehicle is able to be parked in the toll parking lot within a range of the balance; and
outputting a warning message to the display when a time up to the end of available parking duration falls below a predetermined time.

5. The non-transitory computer-readable recording medium according to claim 1, wherein the program causes the processor to execute:
calculating a moving duration for movement from a current location to the toll parking lot, and
outputting a warning message to the display when a time up to the end of available parking duration falls below a sum of the moving duration and a predetermined time.

6. The non-transitory computer-readable recording medium according to claim 1, wherein the program causes the processor to execute outputting, to the display, a moving route from a current location to the toll parking lot.

7. The non-transitory computer-readable recording medium according to claim 1, wherein the program causes the processor to execute:
accepting a payment request for a predetermined payment amount;
determining whether a sum of the payment amount and the parking fee exceeds the balance; and
outputting a warning message to the display when it is determined that the sum exceeds the balance.

8. A payment system comprising:
a payment server comprising a first processor comprising hardware; and
a terminal comprising
a second processor comprising hardware, and
a display, wherein
the first processor is configured to cause the display to display information obtained by a comparison between a parking fee that increases in accordance with a lapse of a parking duration in a toll parking lot and a balance of a payment method.

9. The payment system according to claim 8, wherein the first processor is configured to acquire an entering time of day at which a vehicle enters the toll parking lot.

10. The payment system according to claim 8, wherein the first processor is configured to acquire a fee structure of the toll parking lot.

11. The payment system according to claim 8, wherein the first processor is configured to:
calculate an available parking duration corresponding to a time during which a vehicle is able to be parked in the toll parking lot within a range of the balance; and
cause the display to display a warning message when a time up to the end of available parking duration falls below a predetermined time.

12. The payment system according to claim 8, wherein the first processor is configured to:
calculate a moving duration for movement from a current location to the toll parking lot; and
cause the display to display a warning message when a time up to the end of available parking duration falls below a sum of the moving duration and a predetermined time.

13. The payment system according to claim 8, wherein the first processor is configured to cause the display to display a moving route from a current location to the toll parking lot.

14. The payment system according to claim 8, wherein the first processor is configured to:
accept a payment request for a predetermined payment amount;
determine whether a sum of the payment amount and the parking fee exceeds the balance; and
cause the display to display a warning message when the first processor determines that the sum exceeds the balance.

15. A payment server comprising:
a processor comprising hardware, the processor being configured to cause a display to display information obtained by a comparison between a parking fee that increases in accordance with a lapse of a parking duration in a toll parking lot and a balance of a payment method.

16. The payment server according to claim 15, wherein the processor is configured to acquire an entering time of day at which a vehicle enters the toll parking lot.

17. The payment server according to claim 15, wherein the processor is configured to acquire a fee structure of the toll parking lot.

18. The payment server according to claim 15, wherein the processor is configured to:
calculate an available parking duration corresponding to a time during which a vehicle is able to be parked in the toll parking lot within a range of the balance; and
cause the display to display a warning message when a time up to the end of available parking duration falls below a predetermined time.

19. The payment server according to claim 15, wherein the processor is configured to:
calculate a moving duration for movement from a current location to the toll parking lot; and
cause the display to display a warning message when a time up to the end of available parking duration falls below a sum of the moving duration and a predetermined time.

20. The payment server according to claim 15, wherein the processor is configured to:
accept a payment request for a predetermined payment amount;
determine whether a sum of the payment amount and the parking fee exceeds the balance; and
cause the display to display a warning message when the processor determines that the sum exceeds the balance.
